(19) United States
(12) Patent Application Publication
(10) Pub. No.: US 2008/0150537 A1
(43) Pub. Date: Jun. 26, 2008

(54) Metal detector with discrimination against metal-mimicking minerals

(76) Inventor: Allan Westersten, Georgetown, CA (US)

Correspondence Address: Allan Westersten, P.O. Box 50, Georgetown, CA, 95634-0050, US

(21) Appl. No.: 11/440,721

(22) Filed: May 24, 2006

Related U.S. Application Data
(60) Provisional application No. 60/685,366, filed on May 25, 2005.

(51) Int. Cl. G01V 3/08; G01V 3/10

(52) U.S. Cl. 324/326

(57) ABSTRACT

A pulse-induction type metal detector capable of distinguishing between metal targets and minerals that mimic metals owing to absorption and release of energy. The amount of energy being transferred is measured by comparing the signals generated during specified intervals of a coil energizing pulse train that comprises bipolar current ramps that induce identical signals in metallic targets but differing signals in magnetic minerals. The criterion used to make the distinction between the targets is thus an inherent characteristic of the target and not subject to a particular adjustment of the electronic circuitry, as is the case with conventional metal detectors. This property of the detector makes it usable in industrial applications, where periodic readjustment of the detector is impractical.

Provisional Application No. 60/685,366 filed on May 25, 2006.

### FIELD OF THE INVENTION

The present invention relates to metal detectors and particularly to metal detectors with the ability to distinguish between metals and minerals that mimic metals.

### BACKGROUND

Mineral specimens that mimic metal targets are common. They are known as “hot rocks” in the jargon of prospectors. Some minerals mimic metals by virtue of their conductivity, which is high enough to sustain eddy currents in the specimen, in response to a varying external magnetic field. This is true of some valuable ores, and detecting them is desirable. The more common hot rocks are not valuable, and their presence interferes with the normal operation of metal detectors.

The common type of hot rock is not conductive, but it still interacts with a magnetic field imposed on it by the search head of a metal detector.

Although the present invention is not bound to a particular theory of operation, it is believed that magnetic dipoles in a hot rock absorb and release energy in a way that mimics absorption and release of energy by the magnetic field accompanying eddy currents in a metallic target.

The magnitude of this effect appears to depend on the nature of the matrix in which the dipoles are embedded as well as the total concentration of magnetic material in the specimen. Coercivity of the magnetic material is also a factor, since it has been observed that very soft magnetic materials, like man-made ferrites, and very hard materials, like “lode stone”, do not exhibit the hot-rock effect.

Additionally, the “magnetic viscosity” of some of these rocks causes a phase shift between the vectors of the magnetizing force imposed on a specimen and the resulting field. As a result, a “virtual” resistive signal is generated. This phenomenon is not noticeable in magnetite, where the coupling between adjacent magnetic domains is strong, but it emerges when needles of magnetite are dispersed in an inert matrix, and the coupling between them is relatively weak.

The energy-absorption and magnetic-viscosity signals are additive and the resultant signal amplitude maybe large compared with the reactive signal caused by the presence of the magnetic material.

In ferrous targets, the resistive and reactive signals generated in the receiver coil are antagonistic, and how a particular target is detected depends on which signal predominates. As a result, the conventional discrimination methods do not work well with hot rocks and they may be erroneously identified as non-ferrous targets by conventional metal detectors.

Consequently, there is a need for a metal detector which can differentiate reliably between metals and mineral specimens that mimic metals. The present invention satisfies that need.

The method used in the present invention to measure the energy absorption of hot rocks is similar to, but not the same as the method used to interrogate magnetic memory cores.

The memory effect is based on hysteresis of the magnetic material, and hysteresis has also been used as a basis for differentiating between ferrous and non-ferrous targets in a metal detector.

Payne, in U.S. Pat. No. 4,110,679, uses the phenomenon of hysteresis to reduce the influence of background signals caused by the presence of magnetic minerals in the soil. He uses a “write pulse” and at least two “read pulses” to interrogate the materials within the field of the search head. This technique is similar to the one used in reading memory cores, with the difference that in memory core use, only two states of magnetization are of interest, whereas Payne quantifies the state of magnetization by comparing the signals derived from two sequential read pulses.

A distinctive shortcoming of the above method is the need for manually readjusting the electronic circuitry when the nature of the background medium changes.

In some applications of a metal detector, such as gold prospecting, the magnetic material content of the soil changes frequently and the need for readjusting the detector constitutes a major inconvenience.

In contrast, the circuitry in the present invention includes means for automatic readjustment, using a negative feedback loop. Thus, the optimal operational characteristics of the detector are maintained without the intervention of the operator, even when the amount of magnetic minerals in the soil changes.

### OBJECTS AND ADVANTAGES

It is an object of the present invention to provide a metal detector that is able to differentiate between metal-mimicking minerals and metal targets. It is a further objective of the invention to provide a detector which does not require manual readjustment of its circuitry when the nature of the searched medium changes.

A major advantage of the present invention over prior-art detectors is that it maintains its optimal operational characteristics without periodic intervention by the operator. This advantage makes the invention usable in industrial applications, such as the monitoring of conveyor belts for the presence of metal contamination in ore.

### BRIEF DESCRIPTION OF THE DRAWINGS

FIG. 1 shows a block diagram of the preferred embodiment of the invention.

FIG. 2A shows the transmitter coil current waveform.

FIG. 2B shows the voltage induced in the receiver coil, owing to the mutual inductance between the transmitter and receiver coils.

The above waveform also illustrates the voltage induced in a target.

FIG. 2C shows the eddy currents generated in a conductive target.

FIG. 2D shows the voltages induced in the receiver coil resulting from eddy currents in a conductive target.

FIG. 2E shows the energy-absorption signal generated in the receiver coil.

### DESCRIPTION OF THE PREFERRED EMBODIMENT

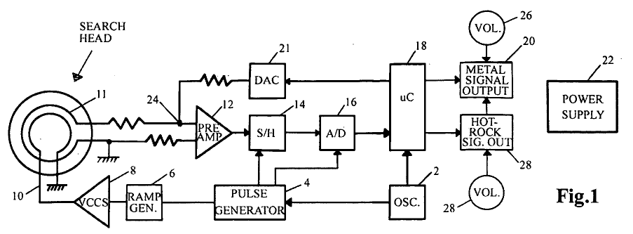

In FIG. 1, oscillator 2 provides clock pulses to microcontroller 18 and pulse generator 4. In response to pulses from pulse generator 4, ramp generator 6 generates linear voltage ramps which are converted to linear current ramps by voltage-controlled current source 8. These current ramps are imposed on transmitter coil 10, with a periodicity that is determined by the frequency of oscillator 2.

The signals generated in receiver coil 11 are amplified by preamplifier 12 and sampled by sample-and-hold circuit 14, at intervals determined by gating pulses issued by pulse generator 4.

A/D converter 16 digitizes the samples and passes them to microcontroller 18.

When the microcontroller determines that the sampled signal meets predetermined criteria, alarm circuit 20 is activated and the operator is alerted by visual or auditory means that a target is within the range of the search head.

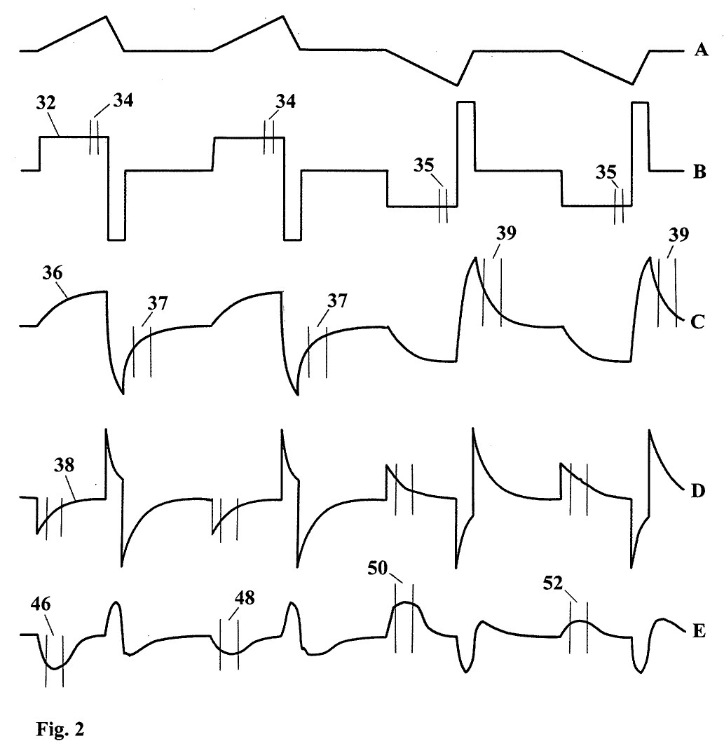

When no alarm is being generated, microcontroller 18 sends a voltage pulse to summing junction 24 of preamp 2, via DAC 21, to essentially neutralize the voltage pulse of FIG. 2B. Thus, the voltages generated in targets and their surrounding media are referenced to essentially zero, instead of being added algebraically to the voltage of FIG. 2B. The effect of this action is that the dynamic range of the preamp is dramatically extended.

The levels at which the metal and hot-rock signals generate usable indicia are set by volume controls 26 and 28, respectively.

Power supply 22 provides the circuitry with the voltages required for its operation.

The functions of all the blocks shown in FIG. 1 are well known to those skilled in the metal-detector art. The novelty of the invention resides in the manner the in which the functional blocks are combined and the way the received signals are processed by microcontroller 18. The above will become more apparent when the operation of the invention is considered, below.

### OPERATION OF THE PREFERRED EMBODIMENT

FIG. 2A shows the waveform of the current through transmitter coil 10. The resulting magnetic flux imposed on the searched medium also has the wave-shape of FIG. 2A. The flux ramp induces a flat-topped voltage pulse 32 in the receiver coil, as shown by FIG. 2B. The magnitude of the pulse is sampled at interval 34 and the voltage is driven to essentially zero by the negative feed-back action, using microcontroller 18 and DAC 21.

Induced voltage 32 engenders eddy currents in conductive media as shown by trace 36 of FIG. 2C, and as a result, target signals 38 are induced in the receiver coil. When the distance between successive coil current pulses is at least four times as long as the time constant of the target, the signals sampled at intervals 46 and 48 are essentially identical for a metal signal shown by trace 38. With the exception of the reversed polarity, the same is true for samples taken at intervals 50 and 52.

FIG. 2E shows the energy-absorption signal. In contrast to the signals derived from a metallic target, the signal samples taken at intervals 46 and 48 do not have the same amplitude. The amplitude of the signal at interval 46 represents the energy required to orient the magnetic domains in the sample in a given direction. Following the magnetizing pulse, the domains tend to return to a disordered state, but absent an active mechanism for changing their orientation, some domains remain in an ordered state.

Thus, less energy is expended to restore the previous state of magnetization of the sample. This is reflected by the lower amplitude of the signal present at interval 48. When the polarity of the magnetizing force is reversed, the cycle starts over.

It can be seen from the above that the behavior of hot rocks and metal targets is distinctly different, when exposed to bi-polar magnetic pulses, and this difference is used in the present invention to distinguish between the two kinds of targets.

Subtracting the signal at interval 48 from the signal at interval 46 yields a measure of the energy absorbed by the hot rock. A similar subtraction of signals generated by a metallic target yields no significant output, which is apparent in FIG. 2D.

It should be noted that the above method to differentiate between hot rocks and metallic targets makes use of the resistive target signals only. The magnetic characteristics of hot rocks will also generate reactive signals, by changing the mutual inductance between the transmitter and receiver coils. However, this signal is nulled out by the negative feedback loop that neutralizes the coupling between the coils.

In normal operation of the invention, the metal signals intercepted at intervals 37 and 39 are added algebraically, and when the sum exceeds a predetermined value, alarm circuit 20 is activated. When a substantial difference between signal samples at intervals 46 and 48 indicates that the target is a hot rock, the metal response is inhibited, or alternately, a separate indication is provided to signal the presence of a hot rock. In either case, a reliable distinction between hot rocks and metallic targets is established.

### RAMIFICATIONS AND SCOPE OF THE INVENTION

The description of the preferred embodiment merely illustrates one way of implementing the invention and it should not be construed as a limitation of the scope of the invention. Likewise, the application of the invention should not be considered useful in the metal detector field only. With only slight modifications of the circuitry, the method of eliciting the energy-absorption effect can be used to measure the concentration of ore that contains magnetic material.

I claim:

1-4. (canceled)

5. In a pulse-induction type metal detector having a transmitter coil, a receiver coil, read-out means and coil-excitation means, the improvement comprising:
means to generate a linear flux.ramp as part of said coil-excitation means.

6. A metal detector as recited in claim 5, wherein the read-out means comprises:
(a) means to differentiate the signals from the receiver coil, and
(b) means to integrate said differentiated signals from the receiver coil, whereby signals intercepted by the receiver coil are essentially restored to their original shape, with the DC components of the signals removed.

7-9. (canceled)

10. In a metal detector having a transmitter coil, a receiver coil, read-out means and coil-excitation means, the method for detecting metal objects, comprising the steps of:
(a) imposing a linear magnetic flux ramp on a location that may contain a metallic target, and
(b) sensing and sampling signals elicited by said flux ramp.

11-18. (canceled)
